(19) United States
(12) Patent Application Publication
(10) Pub. No.: US 2003/0081354 A1
(43) Pub. Date: May 1, 2003

(54) Magnetic actuator latch apparatus for a disc drive

(75) Inventors: Tak Koon Ooi, Singapore (SG); Yiren Hong, Singapore (SG); Chor Shan Cheng, Singapore (SG); Choon Kiat Lim, Singapore (SG)

Correspondence Address: MERCHANT & GOULD PC, P.O. BOX 2903, MINNEAPOLIS, MN, 55402-0903, US

(73) Assignee: Seagate Technology LLC

(21) Appl. No.: 10/265,039

(22) Filed: Oct. 4, 2002

Related U.S. Application Data
(60) Provisional application No. 60/348,783, filed on Oct. 25, 2001.

(51) Int. Cl. G11B 5/54

(52) U.S. Cl. 360/256.2

(57) ABSTRACT

A disc drive has one or more data storage discs rotatably mounted on a spindle motor fastened to a base plate, an actuator assembly fastened to the base plate adjacent the discs for movement of transducer heads over surfaces of the discs, and a voice coil motor coupled to the actuator for moving the transducer heads. The voice coil motor has a bottom pole plate spaced from a top pole plate forming a gap in which a voice coil connected to the transducer heads is free to rotate. A latch mechanism for retaining the transducer heads on a landing zone includes a cylindrical latch member with a gap formed by a circular groove between the bottom pole plate and the top pole plate and a pair of spaced apart upright standoffs adjacent one end of the pole pieces that spaces the bottom pole plate from the top pole plate. The spaced standoffs define an opening between the standoffs wherein the width of the opening operably affects magnetic flux across the groove in the latch member. The upright standoffs forming the opening are integrally formed near one end of a stamped bottom pole plate that is preferably fastened to the top pole plate through the disc drive cover.

### RELATED APPLICATIONS

This application claims the benefit of priority of U.S. provisional application Serial No. 60/348,783, filed Oct. 25, 2001.

### FIELD OF THE INVENTION

This application relates generally to data storage devices and more particularly to a voice coil motor driven actuator assembly in a disc drive data storage device.

### BACKGROUND OF THE INVENTION

Accordingly there is a need for a variable mechanism to adjust the latching force applied to an actuator to minimize the potential for overshoot of the transducers upon unlatching the actuator upon disc drive startup. The present invention provides a solution to this and other problems, and offers other advantages over the prior art.

### SUMMARY OF THE INVENTION

Against this backdrop the present invention has been developed. The disc drive has a base plate, a disc rotatably mounted on a spindle motor fastened to the base plate, and an actuator assembly adjacent the disc carrying a transducer head for movement over the disc. The disc drive has a voice coil motor that has a bottom pole plate mounted on the base plate, a top pole plate spaced from the bottom pole plate by a gap, and a voice coil in the gap operably connected in the actuator assembly to the transducer. A bipolar magnet is positioned on one of the pole plates that generates a magnetic flux across the gap. A latch mechanism for holding the actuator assembly in a predetermined position in accordance with the present invention has a latch member extending between the bottom pole plate and the top pole plate from a mid portion of the bottom pole plate. This latch member has a gap formed by a peripheral groove in the latch member. A latch plate connected to the voice coil contacts the latch member over the gap when the actuator assembly is in the predetermined position. A pair of spaced standoff members adjacent one end of the bottom pole plate spaces the top pole plate from the bottom pole plate. These standoff members form an opening therebetween whose width determines the amount of leakage flux that crosses the gap in the latch member, and thus determines the latch force attracting the latch plate to the latch member in the predetermined position, preferably such as to position the transducer heads on a landing zone on the disc.

These and various other features as well as advantages which characterize the present invention will be apparent from a reading of the following detailed description and a review of the associated drawings.

### BRIEF DESCRIPTION OF THE DRAWINGS

FIG. 1 is a perspective partially exploded view of a disc drive incorporating a preferred embodiment of the present invention with the cover spaced from the base plate showing the primary internal components.

FIG. 2 is a plan view of the disc drive shown in FIG. 1 with the cover and top pole plate removed.

FIG. 3 is an upper perspective view of the bottom pole plate in accordance with a preferred embodiment of the present invention separated from the disc drive shown in FIG. 1, with the magnet and latch member installed on the bottom pole plate.

### DETAILED DESCRIPTION

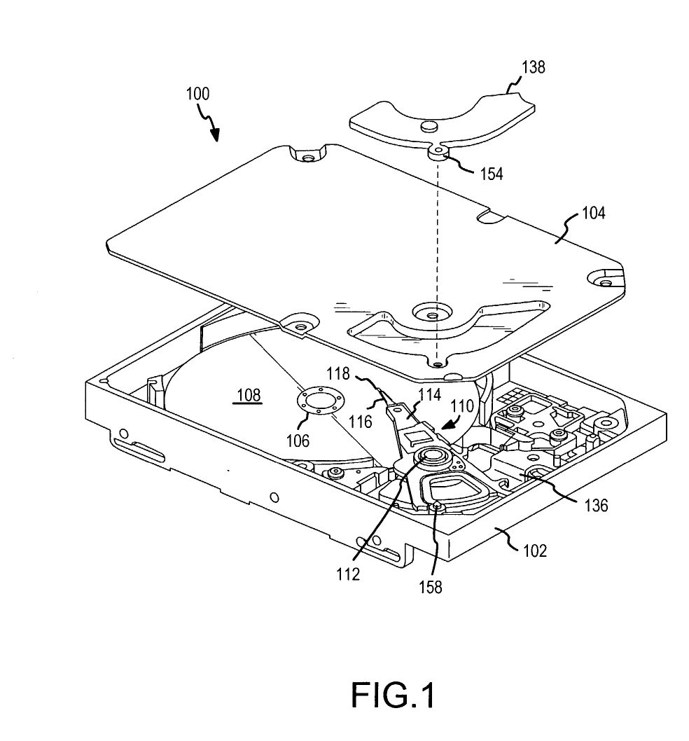

A disc drive 100 constructed in accordance with a preferred embodiment of the present invention is shown in the exploded view of FIG. 1. The disc drive 100 includes a base or base plate 102 to which various components of the disc drive 100 are mounted. A top cover 104, shown above the spaced from the base 102, cooperates with the base 102 to form an internal, sealed environment for the disc drive in a conventional manner. The enclosed components include a spindle motor 106 which rotates one or more discs 108 at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a transducer head 118 which includes an air bearing slider enabling the head 118 to fly in close proximity above the corresponding surface of the associated disc 108.

During a seek operation, the track position of the heads 118 is controlled through the use of a voice coil motor (VCM) 124, which typically includes a coil 126 attached to bearing shaft assembly 112 opposite the actuator arms 114 in the actuator assembly 110, as well as one or more bipolar permanent magnets 128 which establish a magnetic field in which the coil 126 is immersed. The controlled application of current to the coil 126 causes magnetic interaction between the permanent magnets 128 and the coil 126 so that the coil 126 moves in accordance with the well known Lorentz relationship. As the coil 126 moves, the actuator assembly 110 pivots about the bearing shaft assembly 112, and the heads 118 are caused to move across the surfaces of the discs 108.

The spindle motor 106 is typically de-energized when the disc drive 100 is not in use for extended periods of time. The heads 118 are moved over park zones, usually near the inner diameter of the discs 108, when the drive motor is de-energized. The heads 118 are secured over the park zones through the use of an actuator latch arrangement, which prevents inadvertent rotation of the actuator assembly 110 when the heads 118 are parked. In the present invention, this actuator latch arrangement is a magnetic latch 150 which will be described in more detail below.

A flex assembly 130 provides the requisite electrical connection paths for the actuator assembly 110 while allowing pivotal movement of the actuator assembly 110 during operation. The flex assembly includes a printed circuit board 132 to which head wires (not shown) are connected; the head wires being routed along the actuator arms 114 and the flexures 116 to the heads 118. The printed circuit board 132 typically includes circuitry for controlling the write currents applied to the heads 118 during a write operation and a preamplifier for amplifying read signals generated by the heads 118 during a read operation. The flex assembly terminates at a flex bracket 134 for communication through the base 102 to a disc drive printed circuit board (not shown) mounted to the bottom side of the disc drive 100.

The voice coil motor coil 126 is rigidly held in a yoke 140 attached to the actuator arms 114 via the bearing assembly 112 of the actuator assembly 110 and the coil 126 is free to rotate horizontally above the magnet 128 and thus to rotate the actuator arms 114, about a vertical axis through the bearing assembly 112. The direction, either clockwise or counter-clockwise, that the coil 126 rotates, is determined by the direction of current passing through the coil 126.

The voice coil motor magnet 128 is a flat bipolar magnet that has an arcuate shape with an upper surface divided, preferably equally, into a North pole face (N) and a South pole face (S), side by side. The magnet 128 rests on a magnetically permeable bottom pole plate 136 which is fastened to the base 102. An upper pole plate 138 lies parallel to and spaced above the bottom pole plate 136.

In the embodiment shown in FIG. 1, the upper pole plate 138 is located above the cover 104 and resides in a complementarily shaped depression or recess stamped into the cover 104. The cover 104 and the upper pole plate 138 are both made of magnetically permeable material such as steel. Thus the upper pole plate 138 is actually outside the closed environment between the cover and the base 102. In other embodiments, the upper pole plate 138 may be beneath the cover 104 and thus within the closed environment.

In either the embodiment shown in FIG. 1 or other embodiments with the upper pole plate beneath the cover 104, the magnetic flux generated by the magnet 128 passes from one face of the magnet to the magnet's opposite face (flush against the bottom pole plate 136) basically in two closed loops from the magnet 128: from upper face N of the magnet 128, through the gap formed between the upper pole plate 138 and the magnet 128, through the upper pole plate 138 into the end portion of the bottom pole plate 136 against the upper pole plate 138, through the bottom pole plate 136 back to the opposite face of the magnet 128. Flux also passes into the other polarity upper face (S) of the magnet 128, through the magnet 128, through the bottom pole plate 136 to the upper pole plate 138, through the upper pole plate 138, through the gap to the upper face S of the magnet 128 having the opposite polarity.

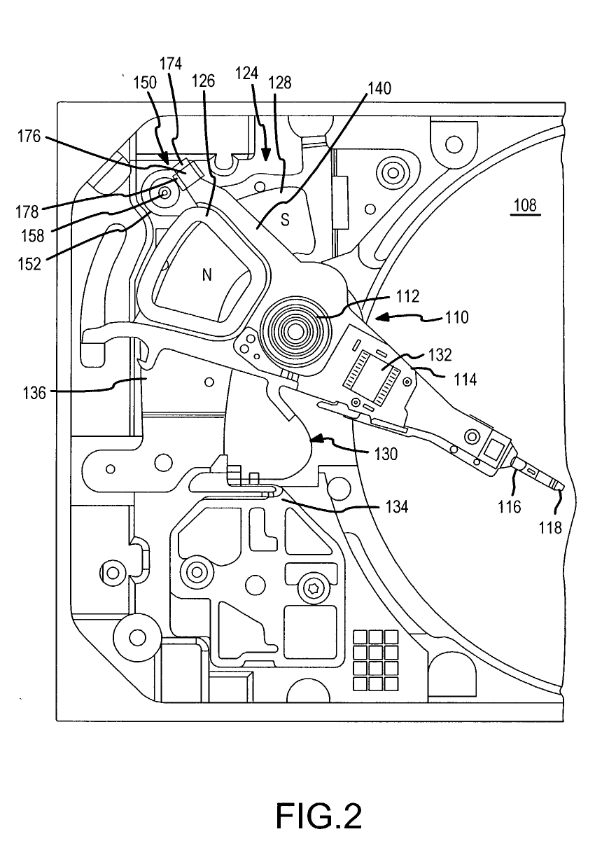

In order to get from the bottom pole plate 136 to the upper pole plate 138, the magnetic flux must either travel through air (i.e., through the gap containing the voice coil 126) or through a magnetically permeable post or “standoff” which separates the two pole plates. In the preferred embodiment of the present invention shown in FIGS. 1-3, this is accomplished by bends or risers formed in each end portion of the bottom pole plate 136 which direct flux to and from the upper pole plate 138.

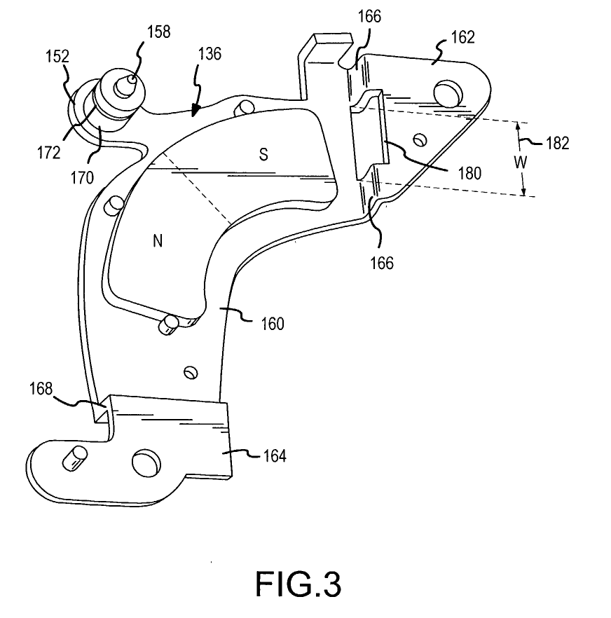

The bottom pole plate 136 is separately shown in FIG. 3. This bottom pole plate 136 is a generally flat, elongated metal plate, preferably made of steel or other magnetic permeable material, having a flat central magnet support portion 160 between end flange portions 162 and 164. These end flange portions 162 and 164 have upper surfaces parallel to the upper face of the magnet support portion 160 and are spaced from the magnet support portion 160 by bent standoff or riser portions 166 and 168 respectively. These bent riser portions 166 and 168 are preferably bent at a right angle to the magnet support portion 160 and extend upward, each merging with its respective end flange portion 162 or 164. When the steel cover 104 is fastened to the base plate 102 with the upper pole plate 138 in place, the upper pole plate 138 effectively connects the flange portions 162 and 164 of the bottom pole plate 136 through the cover 104 to complete the magnetic circuits described above.

The actuator latch apparatus 150 in accordance with the present invention involves the use of the bottom pole plate 136 and the upper pole plate 138. In particular, each pole plate 136 and 138, in the preferred embodiment shown, is originally a generally flat magnetically permeable plate. This plate is stamped to form the opening 180 and the upright riser portions 166 and 168. Each plate has an integral circular tab 152 and 154 respectively extending outward from the convex outer edge of each of the pole plate 136 and pole plate 138. The bottom circular tab 152 has a vertical pin 158 extending upward from the tab 152. Positioned on this pin 158 is a latch cylinder 170 that has a circular peripheral groove 172. The groove 172 forms a gap in the cylindrical surface of the latch cylinder 170 which causes a portion of the magnetic flux traveling through the latch cylinder 170 to pass through the air in and adjacent this gap.

The actuator yoke 140 has a latch tab 174 that extends rearward from the yoke 140. Attached to this latch tab 174 via an elastomeric mount 176 is a magnetically permeable latch plate 178. This latch plate 178, when in close proximity to the groove 172, is drawn to and contacts the surface of the latch cylinder 170 over the groove 172 and thus straddles the gap, e.g., the grove 172 to latch the yoke 140 and voice coil 126, and hence the actuator assembly 110 in a parked position with the heads 118 on the landing zone of the discs 108.

The bent upright portion 166 between the central portion 160 and the flange portion 162 of the bottom pole plate 136 forms two upright sections with a central opening 180 therethrough. This bent upright portion 166 could, in other embodiments of the invention, be constructed by separate spaced apart standoffs or posts made of magnetically permeable material. However, a one-piece pole plate construction of pole plate 136 is preferred because of its ease of manufacture. The opening 180, or spacing between the standoffs or risers 166 is important in the present invention. Preferably this opening 180 is rectangular and extends from the base portion 160 to the flange portion 162. The width of the opening 180 determines the cross sectional area of the risers 166 and hence the amount of leakage magnetic flux that passes over and across the groove 172 in the latch cylinder 170. Thus the magnitude of the latch force exerted on the latch plate 178 can be adjusted by changing the width of the opening 180. In the preferred embodiment 150, this adjustment is incorporated into the design of the stamping process, i.e. forming the bottom pole plate 136.

The voice coil motor current necessary to unlatch the actuator assembly 110 is proportional to the magnitude of the magnetic flux holding the latch plate 178 to the latch cylinder 170. However, once the actuator 110 is unlatched, the latch plate 178 is no longer held to the latch cylinder 170 and the unlatching current can cause the heads 118 in the actuator assembly 110 to be abruptly driven toward the outer diameter of the disc 108. By adjusting the width 182 of the opening 180, an optimum latch force can be chosen that is sufficient to retain the heads 118 in the landing zone when the drive is de-energized and yet small enough so that the voice coil motor current necessary to reliably unlatch the actuator assembly 110 does not cause excessive overshoot of the actuator assembly 110 away from the landing zone upon drive startup.

In one exemplary 3½ inch form factor drive in accordance with the present invention, the width of the opening 180 is approximately 0.345 inch. However, this width opening is merely representative, and depends on the geometry of the latch plate, the latch cylinder 170, the strength of the magnet 128, the material of the latch member 170, cover 104, the pole plates 136 and 138 and the depth and width of the groove 172.

In the embodiment shown, magnetic flux from the magnet face (S) flows through the magnet 128 into the bottom pole plate 136 and then splits into two basic paths to get to the top pole plate 138. First, the flux may travel up through the upright standoff portions or risers 166 to the flange portion 162, thence through the cover 104 to the top pole plate 138. From there the flux crosses the vertical gap between the plates 136 and 138 to return into the magnet face (S). The second path is through the magnet 128 into the bottom pole plate 136, through the plate 136 to the tab 152, through the cylindrical latch member 170 through the cover 104 to the tab 154 on the top pole plate 138, thence also across the vertical gap to the magnet face (S) of the magnet 128.

The cross sectional area of the upright portion or risers 166 is decreased by increasing the width 182 of the opening 180. This reduces the amount of magnetic flux traveling via the first path to the top pole plate 138 and re-proportions the flux through the latch member 170. This, in turn, increases the leakage or fringe flux crossing the gap formed by the groove 172 and thus increases the potential latch force on the latch plate 178. Conversely, a reduced width 182 of the opening 180 reduces the fringe flux across the gap formed by the groove 172 thus reducing the potential latch force. This arrangement provides a simple structure for adjusting the magnetic latch force during the drive design and manufacturing process.

In summary, the present invention may be viewed as a disc drive (such as 100) having a base plate (such as 102), a disc (such as 108) rotatably mounted on a spindle motor (such as 106) fastened to the base plate, an actuator assembly (such as 110) adjacent the disc carrying a transducer head (such as 118) for movement over the disc (such as 108). The disc drive (such as 100) includes a voice coil motor (such as 124) having a bottom pole plate (such as 136) mounted on the base plate (such as 102), a top pole plate (such as 138) spaced from the bottom pole plate by a gap, a magnet (such as 128) on one of the pole plates (such as 136 or 138) generating a magnetic flux across the gap, and a voice coil (such as 126) in the gap operably connected in the actuator assembly (such as 110) to the transducer (such as 118). The drive (such as 100) has a latch mechanism (such as 150) for holding the actuator assembly (such as 110) in a predetermined position comprising a latch member (such as 170) extending between the bottom pole plate (such as 136) and the top pole plate (such as 138) from a mid portion (such as 160) of the bottom pole plate (such as 136). The latch member (such as 170) has a groove (such as 172) therein. A pair of spaced standoff members (such as 166) adjacent one end (such as 162) of the bottom pole plate (such as 136) space the top pole plate (such as 138) from the bottom pole plate (such as 136). The standoff members (such as 166) form an opening (such as 180) therebetween. A latch plate (such as 178) connected to the voice coil (such as 126) is positioned to contact the latch member (such as 170) over the groove (such as 172) when the actuator assembly (such as 110) is in the predetermined position.

The spaced standoff members are preferably formed by two bent upright portions (such as 166) of the bottom pole plate (such as 136) connecting a mid portion (such as 160) to one flange end portion (such as 162) of the bottom pole plate (such as 136). The latch member (such as 170) is a post or cylinder positioned between the bottom pole plate (such as 136) and the top pole plate (such as 138) having a gap such as a circular groove (such as 172) therearound. The bottom pole plate (such as 136) and the top pole plate (such as 138) each have a latch tab (such as 152 and 154) extending therefrom supporting the latch member (such as 170). The opening (such as 180) preferably extends from the mid portion (such as 160) to the flange portion (such as 162) of the bottom pole plate (such as 136).

Alternatively, the present invention may be viewed as a latch mechanism (such as 150) for retaining the transducer heads (such as 118) in a predetermined position in a disc drive (such as 100). The drive has one or more data storage discs (such as 108) rotatably mounted on a spindle motor (such as 106) fastened to a base plate (such as 102), an actuator assembly (such as 110) fastened to the base plate (such as 102) adjacent the discs (such as 108) for movement of transducer heads (such as 118) over surfaces of the discs, and a voice coil motor (such as 124) coupled to the actuator (such as 110) for moving the transducer heads (such as 118). The voice coil motor (such as 124) has a bottom pole plate (such as 136) spaced from a top pole plate (such as 138) forming a gap in which a voice coil (such as 126) connected to the transducer heads (such as 118) is free to rotate. A magnet (such as 128) on one of the pole plates generates a magnetic flux across the gap. The latch mechanism (such as 150) includes a latch member (such as 170) extending between the bottom pole plate (such as 136) and the top pole plate (such as 138) having a gap preferably in the form of a groove (such as 172) therein, a pair of spaced apart upright standoffs (such as 166) adjacent one end of the pole pieces (such as 136 and 138) spacing the bottom pole plate (such as 136) from the top pole plate (such as 138) defining an opening (such as 180) between the standoffs (such as 166), wherein the width (such as 182) of the opening (such as 180) operably affects magnetic flux across the groove (such as 172) in the latch member (such as 170). A latch plate (such as 178) is connected to the voice coil (such as 126) and is positioned to cover the groove (such as 172) in the latch member (such as 170) when the transducer heads (such as 118) are in the predetermined position.

The latch upright standoffs (such as 166) are preferably bent portions (such as 166) of the bottom pole plate (such as 136). The latch member (such as 170) is a cylindrical post extending vertically from a tab portion (such as 152) of the bottom pole plate (such as 136) spaced from the magnet (such as 128) to a tab portion (such as 154) of the top pole plate (such as 138). The groove in the cylindrical post (such as 170) is a peripheral circular groove (such as 172). The top pole plate (such as 138) is preferably positioned external to and in a recess within the cover (such as 104) on the base plate (such as 102), together enclosing the actuator assembly (such as 110), the discs (such as 108) and the spindle motor (such as 106).

Alternatively, the present invention may be viewed as a disc drive (such as 110) having one or more data storage discs (such as 108) rotatably mounted on a spindle motor (such as 106) fastened to a base plate (such as 102) and an actuator assembly (such as 110) fastened to the base plate adjacent the discs for movement of transducer heads (such as 118) over surfaces of the discs, and a voice coil motor (such as 124) coupled to the actuator (such as 110) for moving the transducer heads (such as 118). The voice coil motor (such as 124) has a bottom pole plate (such as 136) spaced from a top pole plate (such as 138) forming a gap in which a voice coil (such as 126) connected to the transducer heads (such as 118) is free to rotate and a magnet (such as 128) on one of the pole plates generating a magnetic flux across the gap.

The disc drive includes a latch mechanism (such as 150) for retaining the transducer heads (such as 118) in a predetermined position on the discs (such as 108) and means in the voice coil motor (such as 124) for adjusting magnetic latch force exerted by the latch mechanism (such as 150) on the voice coil (such as 126) in the predetermined position. The latch mechanism (such as 150) comprises a latch member (such as 170) extending between the bottom pole plate (such as 136) and the top pole plate (such as 138) and a latch plate (such as 178) connected to the voice coil (such as 126). The means for adjusting preferably comprises a pair of spaced upright bends (such as 166) in the bottom pole plate (such as 136) spacing the top pole plate (such as 138) from the bottom pole plate and forming an opening (such as 180) therebetween. The latch member may be a post or cylinder (such as 170) having a gap preferably formed by a peripheral circular groove (such as 172) and the latch plate (such as 178) is preferably positioned to straddle the groove when the latch plate (such as 178) contacts the latch member (such as 170).

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, the opening 180 may be a different shape such as circular or a trapezoidal shape. The opening 180 need not extend completely from the base portion to the flange portion. Thus the opening may be a lateral slot in the bent portion between the base and the flange portions. The latch member 170 may be other than a cylindrical shape. It may be rectangular, triangular or other shape. It may be simply an upright tab extending from the bottom pole plate to the top pole plate 138. Alternatively it may extend from the top pole plate 138 downward to the bottom pole plate 136. Similarly, the groove 172 may be other than a circular groove. It may simply be a surface discontinuity that causes some magnetic flux passing through the latch member 170 to leak through the air adjacent the latch member 170 such that the leakage flux preferentially flows through the latch plate 178 when the latch plate 178 is in close proximity to the discontinuity, gap or groove 172. Numerous other changes may be made which will readily suggest themselves to those skilled in the art and which are encompassed in the spirit of the invention disclosed and as defined in the appended claims.

What is claimed is:

1. A disc drive having a base plate, a disc rotatably mounted on a spindle motor fastened to the base plate, an actuator assembly adjacent the disc carrying a transducer head for movement over the disc, the disc drive comprising:
a voice coil motor having a bottom pole plate mounted on the base plate, a top pole plate spaced from the bottom pole plate by a gap, a magnet on one of the pole plates generating a magnetic flux across the gap, and a voice coil in the gap operably connected in the actuator assembly to the transducer; and
a latch mechanism for holding the actuator assembly in a predetermined position comprising a latch member extending between the bottom pole plate and the top pole plate from a mid portion of the bottom pole plate, the latch member having a gap therein, a pair of spaced standoff members adjacent one end of the bottom pole plate spacing the top pole plate from the bottom pole plate, the standoff members forming an opening therebetween, and a latch plate connected to the voice coil and positioned to contact the latch member over the gap when the actuator assembly is in the predetermined position.

2. The disc drive according to claim 1 wherein the spaced standoff members are formed by two bent upright portions of the bottom pole plate connecting a mid portion to one flange end portion of the bottom pole plate.

3. The disc drive according to claim 2 wherein the latch member is a cylinder positioned between the bottom pole plate and the top pole plate and the gap is formed by a circular groove around the cylinder.

4. The disc drive according to claim 3 wherein the bottom pole plate and the top pole plate each have a latch tab extending therefrom supporting the latch member.

5. The disc drive according to claim 2 wherein the opening extends from the mid portion to the flange portion of the bottom pole plate.

6. In a disc drive having one or more data storage discs rotatably mounted on a spindle motor fastened to a base plate, an actuator assembly fastened to the base plate adjacent the discs for movement of transducer heads over surfaces of the discs, and a voice coil motor coupled to the actuator for moving the transducer heads, the voice coil motor having a bottom pole plate spaced from a top pole plate forming a gap in which a voice coil connected to the transducer heads is free to rotate and a magnet on one of the pole plates generating a magnetic flux across the gap, a latch mechanism for retaining the transducer heads in a predetermined position comprising:
a latch member extending between the bottom pole plate and the top pole plate;
a pair of spaced apart upright standoffs adjacent one end of the pole pieces spacing the bottom pole plate from the top pole plate defining an opening between the standoffs, wherein the width of the opening operably affects magnetic flux in the latch member; and
a latch plate connected to the voice coil positioned to engage the latch member when the transducer heads are in the predetermined position.

7. The latch mechanism according to claim 6 wherein the upright standoffs are bent portions of the bottom pole plate.

8. The latch mechanism according to claim 6 wherein the latch member is a post extending vertically from a tab portion of the bottom pole plate spaced from the magnet to a tab portion of the top pole plate.

9. The latch mechanism according to claim 8 wherein the post has a peripheral groove.

10. The latch mechanism according to claim 7 wherein the top pole plate is positioned external to a cover on the base plate enclosing the actuator assembly, the discs and the spindle motor.

11. A disc drive having one or more data storage discs rotatably mounted on a spindle motor fastened to a base plate and an actuator assembly fastened to the base plate adjacent the discs for movement of transducer heads over surfaces of the discs, and a voice coil motor coupled to the actuator for moving the transducer heads, the voice coil motor having a bottom pole plate spaced from a top pole plate forming a gap in which a voice coil connected to the transducer heads is free to rotate and a magnet on one of the pole plates generating a magnetic flux across the gap, the disc drive comprising:
a latch mechanism for retaining the transducer heads in a predetermined position on the discs; and
means in the voice coil motor for adjusting magnetic latch force exerted by the latch mechanism on the voice coil in the predetermined position.

12. The disc drive according to claim 11 wherein the latch mechanism comprises a latch member extending between the bottom pole plate and the top pole plate and a latch plate connected to the voice coil.

13. The disc drive according to claim 12 wherein the means for adjusting comprises a pair of spaced upright bends in the bottom pole plate spacing the top pole plate from the bottom pole plate and forming an opening therebetween.

14. The disc drive according to claim 12 wherein the means for adjusting comprises a pair of spaced standoffs adjacent one end of the bottom pole plate forming an opening therebetween.

15. The disc drive according to claim 13 wherein the latch member is a post extending between the bottom pole plate and the top pole plate that forms a gap adjacent the latch plate.

16. The disc drive according to claim 15 wherein the gap is a peripheral groove around the post.

17. The disc drive according to claim 11 wherein the latch mechanism comprises a latch member directing a portion of magnetic flux from the magnet between the top and bottom pole plates and the adjusting means operably affects the portion of magnetic flux passing through the latch member.

18. The disc drive according to claim 17 wherein the latch member is a post extending between the top and bottom pole plates having a gap therein.

19. The disc drive according to claim 18 wherein the means for adjusting comprises a pair of spaced upright bends in the bottom pole plate spacing the top pole plate from the bottom pole plate and forming an opening therebetween whose width adjusts the portion of magnetic flux through the latch member.

20. The disc drive according to claim 13 wherein the latch member is a cylinder having a peripheral circular groove and the latch plate is positioned to straddle the groove when the latch plate contacts the latch member.
